(19) United States
(12) Patent Application Publication
(10) Pub. No.: US 2006/0153207 A1
(43) Pub. Date: Jul. 13, 2006

(54) PHYSICAL ADDRESS BASED ROUTING FOR INTERNET PROTOCOL BASED DEVICES

(75) Inventors: Sammy X. HO, Reston, VA (US); Bruce S. Harrison, Fairfax Station, VA (US)

Correspondence Address: SUGHRUE MION, PLLC, 2100 PENNSYLVANIA AVENUE, N.W., SUITE 800, WASHINGTON, DC, 20037, US

(73) Assignee: NEXT GENERATION BROADBAND

(21) Appl. No.: 11/275,501

(22) Filed: Jan. 10, 2006

Related U.S. Application Data
(60) Provisional application No. 60/642,142, filed on Jan. 10, 2005.

(51) Int. Cl. H04L 12/56

(52) U.S. Cl. 370/401

(57) ABSTRACT

In a computer network comprising a Central System, Internet Protocol (IP) based network, one or more parallel Application Systems and one or more End Devices wherein the End Device receives an IP address and device configuration information from IP Address Server associated with the Central System, a central computer based system identifies one or more End Devices by their unique physical address, and based on that physical address, determines how an individual End Device and other network elements and applications should be configured to ensure that traffic is routed between the end device and a specific Application System. Aspects of an Application System may include a computer system or autonomous network of computers. When an IP Address Server is configured with Physical Address Routing, the IP Address Server can dynamically identify the Application System to which an End Device belongs and provide that End Device with configuration and routing instructions.

### CROSS-REFERENCE TO RELATED APPLICATIONS

The present application claims the benefit of U.S. provisional application No. 60/642142, filed on Jan. 10, 2005 in the United States Patent and Trademark Office, the disclosure of which is incorporated herein in its entirety by reference. This priority claim under 119(e) is being made concurrently with the filing of this application.

### BACKGROUND

1. Technical Field

The exemplary embodiments described herein relate to a system and method for physical address-based routing for Internet Protocol (IP)-based devices, and more specifically, a system and method for performing said physical address-based dynamic routing in a dynamic manner.

2. Related Art

The Internet is built using related art IP protocols for routing and switching. The IP protocol is defined comprehensively in the collection of RFCs (Requests for Comment) from the Internet Engineering Task Force (IETF). In the related art IP routing, it is assumed that each router or networking device knows only its neighboring routers. Further, based on information such as routing tables and informational messages sent to the router or networking device by its neighbors, it can infer and calculate the topology of the entire IP network and select routes for transmission of IP traffic.

An essential function in IP routing is the assignment of one or more IP addresses to each network device. In many cases, IP addresses are dynamically assigned. When an IP address is dynamically assigned, the end device requests an IP address from an IP Address Server. Examples of IP Address Server include but are not limited to Dynamic Host Configuration Protocol (DHCP) servers and RADIUS servers. If the IP address is dynamically provided, the IP Address Servers such as a DHCP server provide that device an IP address and basic configuration information.

In the related art, IP addresses can be dynamically provided. However, related art methods do not permit end devices or network elements to be dynamically configured. The related art does not provide a method such that when an IP address is provided to a specific end device, the network is dynamically configured to ensure that a specific end device is associated with a specific parallel or peer application system or network. In other words, the related art network is so configured such that all network traffic between that end device and application system flows across a specific route between these two or more network elements.

### SUMMARY OF THE INVENTION

Illustrative, non-limiting embodiments of the present invention overcome the above disadvantages and other disadvantages not described above. Also, the present invention is not required to overcome the disadvantages described above, and illustrative, non-limiting embodiment of the present invention may not overcome any of the problems described above.

In a computer network comprising a Central System, Internet Protocol (IP) based network, one or more parallel Application Systems and one or more End Devices where by the End Device receives an IP address and device configuration information from IP Address Server associated with the Central System, a central computer based system is enabled to identify one or more End Devices by their unique physical address and based on that physical address, determine how an individual End Device and other network elements and applications should be configured to ensure that traffic to and from that end device is routed to a specific Application System.

Aspects of an Application System may include a computer system or autonomous network of computers. When an IP Address Server is configured with Physical Address Routing, the IP Address Server can dynamically identify the Application System to which an End Device belongs and provide that End Device with configuration and routing instructions. As a result, the End Device is configured to send its IP traffic along a specific route. If necessary, the Physical Address Routing system can configure other network elements internal to the IP network, Application System and Central System to ensure that IP traffic flows between the desired computer system(s) and across the desired network paths.

### BRIEF DESCRIPTION OF THE DRAWINGS

The exemplary embodiment will be better understood from the detailed description below, in consideration of the non-limiting, explanatory drawing figure which is now briefly described.

FIG. 1 illustrates an IP based network system with parallel application systems according to an exemplary, non-limiting embodiment.

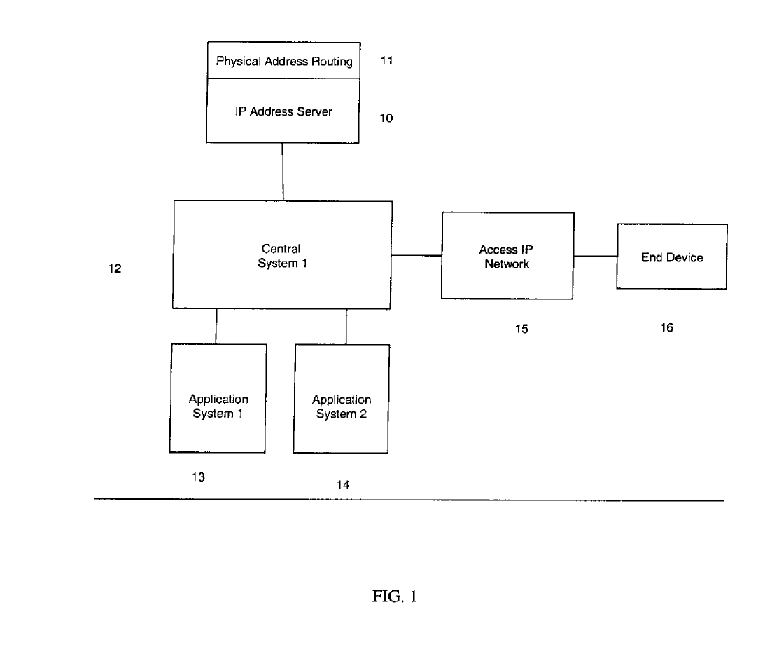

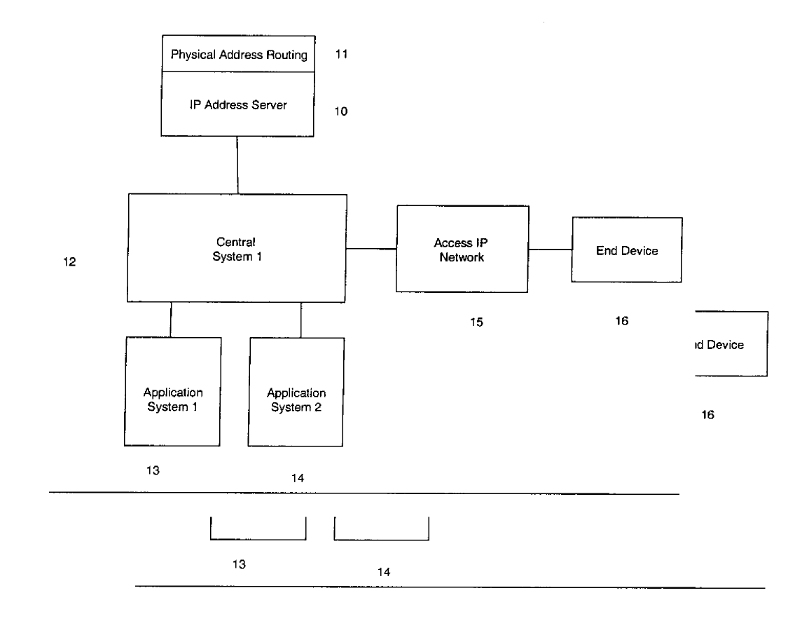

### DETAILED DESCRIPTION OF THE EXEMPLARY EMBODIMENT

Hereinafter, the exemplary embodiment will be described in detail with reference to the attached drawing.

Physical Address Based Routing requires a network comprised of an IP Address Server 10, a Central System 12, a plurality of Application Systems 13, 14, an Access IP Network 15 and End Devices 16.

The IP Address Server 10, Central System 12 and Application Systems 13, 14 are typically located in a single physical location or across a small number of different physical locations. This physical location may be referred to as a Data Center.

The Central System 12 comprises the software applications, services and network elements required to provide Internet Access services and manage network based applications.

Application System 13 & 14 may include (but are not limited to) an application or network service that operates as a peer to the Central System. Examples of Application System may include but are not limited to a second ISP infrastructure or a parallel system to support a different class of customers such as pre paid customer or new, where service is not yet activated.

End device 16 provides functionality and services to remote locations and may include a variety of devices such as personal computers, cable modems, DSL routers, wireless terminals or any IP enabled end device.

The Access IP Network 15 is configured to connect Central System 12 Application Systems 13 & 14 to the End Devices 16. There may be a large number of End Devices 16 located at many different physical locations such as data centers, customer domiciles and places of businesses.

The IP Address Server 10 is a part or adjunct to the Central System 12. In an IP based system, all network devices that connect to Access IP network 15 require an IP address. In the Physical Address Routing process, multiple end devices receive their IP address from IP Address Servers 10. Examples of IP Address Server 10 include a DHCP server or a Radius Server.

The Physical Address Routing system 11 is installed on IP Address Server 10 and operates cooperatively with the IP Address Server's functionality. When an end device requests an IP address, that request is sent through the Access IP Network 15 and Central System 12 to the IP Address Server 10. The IP Address Server 10 begins the process of the assigning IP address based on assigned rules.

For the IP Address Server 10 to fulfill and respond to a single IP address request from the end device, it performs a variety of steps in a substantially linear manner. The IP Address Server 10 is configured to insert the Physical Address Routing 11 into this path. At this point, the Physical Address Routing 11 reviews the requests, determines the physical address of the end device, and based on its own data tables, determines if the end device should receive an IP address from the Central System's IP Address Server 11 or from the parallel application system 13 & 14.

If Physical Address Routing 11 determines that an IP address should be provided by the Application System 13 or 14, the Central System's IP Address Server 10 is instructed to forward the End Device's 16 IP Address request to the Application System 13 or 14 to be fulfilled.

The IP Address Server 10 simultaneously handles and processes IP address from one or more different end devices. Each processing thread is handled separately and uniquely.

Operation

An End Device 16 requests an IP address.

The IP Address request transverses the Access IP Network 15 to the Central System 12.

The Central System 12 sends the request to the IP Address Server 10.

The IP Address Server 10 processes the request in cooperation with Physical Address Routing 11.

The Physical Address Routing 11 examines the IP requests, determines the End Devices 16 IP address. The Physical Address Routing 11 checks a data base to determine if the IP Address Server 10 should provide the IP address and supplemental data or if a parallel Application Server 13 or 14 should provide IP Address and supplemental data to the End Device 16.

If the IP Address Server should provide the IP address, the Physical Address Routing 11 lets IP Address Server continue its processing. If Physical Address Routing 11 determines that the Application System 13 or 14 should be one that provides the IP address, Physical Address Routing 11 instructs the IP Address Server 10 to forward that request to the Application Server 13 or 14 and instructs the IP Address Server 10 to stop processing the request.

At this point, the Application System 13 or 14 then provides the end device 15 with the appropriate IP address and various supplemental information that End Device 16 may require for its configuration. If other network elements need be configured, then Physical Address Routing 11 also configures appropriate network elements based on a pre defined set of business. The business rules are configured as part of the installation and configuration of the Physical Address Routing software.

The foregoing exemplary, non-limiting embodiments have various advantages. However, these embodiments do not require these advantages in order for the invention to be practiced in its best mode.

For example, Physical Address based Routing operates cooperatively with existing standards based IP Address Servers. It may be implemented as a software application that operates cooperatively with one or more IP Address Servers, or as a hardware appliance that performs the same function.

The exemplary embodiment adds a new level of intelligence to the process of dynamically delivering IP addresses and configuring end devices and network elements. It builds on the related art by providing the intelligence necessary to control the routing and flow of IP traffic between specific applications and end devices without requiring additional hardware to be added to the network. Examples of an end device include but are not limited to customer premise equipment such as cable modems, FTTX terminals and DSL modems, personal computers and home networking wired and wireless routers, game terminals, and portal video devices. The Physical Address Routing System may a computer hardware or software device.

With Physical Address based Routing, an IP Address server that dynamically provides end devices with their IP address is augmented with the capability to (1) read the physical address of the end device and (2) based on that physical address, forwards that IP request to a specific IP Address Server in a network that may have many IP Address Servers. The selected IP Address Server then based on the physical address of the end device provides a unique IP address, routing and configuration information to the end device.

The exemplary embodiment also includes the intelligence to configure specific network elements to ensure that a specific end device's IP traffic is controlled and managed in a specific manner. The end result is that both the network and end device are configured such that its IP traffic from the end device follows a defined route or path towards a designated and separate IP network or computer system.

The advantage of using the end device's physical address is that it is hard coded into a device and cannot be altered.

Another advantage of the Physical Address Based Routing is that Physical Address Based Routing enables an end device to be identified and associated with a particular application system that may be part of, or unique from the Central System.

The Central System is the collection of software applications and computer that may be used to manage and deliver network based and Internet based applications. For example but not by way of limitation, in a high speed data network, Physical Based Address Routing can be used to associate an end device with a specific application system and ensure that end device's IP traffic is routed to specified application system. Examples of network based applications include but are not limited to operational support software, network management software or application software that can control the end user's experience and their network service.

While the present invention has been particularly shown and described with reference to exemplary embodiments thereof it will be understood by those of ordinary skill in the art that various changes in form and details may be made therein without departing from the spirit and scope of the present invention as defined by the following claims.

1. A system for physical address based routing in a network, said system comprising:
an IP Address Server configured to generate and assign an IP address based on a set of rules, said IP Address Server further comprising a Physical Address router that operates in accordance with the IP Address Server
a Central System, including at least one of a software application, a service and a network element, that provides Internet Access services and manages network-based applications.
an Application System that operates as a peer to said Central System, wherein said IP Address Server, said Central System and said Application System are proximally positioned with respect to each other at a Data Center or located in separate data centers,
at least one End Device that provides functionality and services to remote locations and includes at least one of a personal computer, a cable modems, a DSL routers, and a wireless terminals, said end device being connectable to said network in accordance with said IP Address, said IP Address Server being configured to process said IP address separately and uniquely from other ones of said End Device, and
an Access IP Network configured to couple said Central System and said plurality of Application Systems to said End Device in accordance with said IP Address,
wherein a request from said end device for said IP address is sent through the Access IP Network and the Central System to the IP Address Server, the Physical Address router is configured to (a) determine a physical address of the end device in accordance with said request, and (b) based on data tables in said Physical Access Router, determine whether the end device should receive said IP address from the IP Address Server or from the said application systems, and if the Physical Address router determines that said IP address should be provided by the Application System, the IP Address Server is instructed to forward the IP Address request of the End Device to the Application System.
